(19) United States
(12) Patent Application Publication
(10) Pub. No.: US 2007/0284995 A1
(43) Pub. Date: Dec. 13, 2007

(54) Plasma display panel

(76) Inventors: Tae-Joung Kweon, Suwon-si (KR); Eun-Gi Heo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,206

(22) Filed: Feb. 23, 2007

(30) Foreign Application Priority Data
Feb. 27, 2006 (KR) 10-2006-0018868

(51) Int. Cl. H01J 17/49

(52) U.S. Cl. 313/484

(57) ABSTRACT

A plasma display panel includes a first substrate and a second substrate opposite to the first substrate. Discharge electrodes are arranged between the first and second substrates and are buried in a dielectric layer. A barrier structure having plurality of barrier ribs is installed between the first and second substrates, defining discharge cells. Phosphor layers are formed within the discharge cells. The first substrate is colored with a first coloring layer, and one of the dielectric layer, the barrier structure, and the phosphor layers is colored with a second coloring layer.

### CROSS-REFERENCE TO RELATED APPLICATION

This application claims the benefit of Korean Patent Application No. 10-2006-0018868, filed on Feb. 27, 2006, in the Korean Intellectual Property Office, the disclosure of which is incorporated herein by reference in its entirety.

### BACKGROUND

1. Field

The present disclosure relates to a plasma display panel (PDP), and more particularly, to a PDP structure decreasing reflection of light transmitted from outside.

2. Discussion of the Related Technology

PDPs are flat display devices that display desired numbers, characters, or graphics by applying a discharge voltage to a discharge gas between two substrates with a plurality of electrodes formed on the substrates to generate ultraviolet (UV) rays between the two electrode groups, and applying a suitable pulse voltage to intersections of the two electrode groups to address the intersections.

Typically 3-electrode surface discharge PDPs include a first substrate and a second substrate. X electrodes and Y electrodes are arranged on the inside surface of the first substrate and buried in a first dielectric layer. The first dielectric layer is covered by a protection layer. Address electrodes are arranged on the inside surface of the second substrate. Barrier ribs that define discharge cells are interposed between the first and second substrates. Red phosphor layers, green phosphor layers, and blue phosphor layers are formed on spaces defined by the barrier ribs.

In PDPs having such a structure, when an electrical signal is applied to the address electrodes and the Y electrodes, discharge cells that are to emit light are selected. When an electrical signal is alternately applied to the X electrodes and the Y electrodes, visible light is emitted from the phosphor materials of phosphor layers coated in the selected discharge cells, thus producing a still image or a moving image.

The foregoing discussion is to provide general background information and does not constitute an admission of prior art.

### SUMMARY

In one aspect of the invention provides a plasma display device, which comprises: a first substrate colored with a first color; a second substrate opposite to the first substrate; a plurality of barrier ribs interposed between the first and second substrates, wherein the plurality of barrier ribs define a plurality of cells; a plurality of sustain electrodes interposed between the first substrate and the plurality of cells; a first dielectric layer, wherein the plurality of sustain electrodes are interposed between the first substrate and the first dielectric layer; a plurality of address electrodes arranged between the plurality of cells and the second substrate; a second dielectric layer, wherein the plurality of address electrodes are interposed between the second dielectric layer and the second substrate; a phosphor layer formed within at least part of the cells; and a second colored layer colored with a second color formed on one or more of at least part of the second dielectric layer, the plurality of barrier ribs, and the phosphor layer, wherein the first color and the second color are adapted to form a subtractive color mixing.

In the foregoing device, the first substrate may comprise a glass plate and a film formed between the glass plate and the first dielectric layer, wherein the film may be of the first color. The film may be formed on a substantially entire surface of the glass plate. The first substrate may comprise a glass plate incorporating a material of the first color. The first and second colors may be substantially complementary. The first substrate may be configured to substantially transmit visible light generated from at least part of the cells. The first substrate comprises a first portion colored with the first color, wherein the second colored layer comprises a second portion colored with the second color, and wherein the first portion and the second portion may be substantially aligned with each other such that light transmitting through the first portion can reach the second portion.

Still in the foregoing device, the plurality of barrier ribs may have side surfaces defining walls of the cells, wherein the second colored layer may be formed on substantially the entirety of the side surfaces. The plurality of barrier ribs may have top surfaces opposing the first substrate, wherein the second colored layer may be formed on substantially the entirety of the top surfaces. The first color and the second color may be adapted to form a subtractive color mixing. The first substrate may be configured to selectively transmit a component of visible light from outside the device into at least part of the cells, wherein the second colored layer may be configured to absorb a substantial amount of the component of visible light that reaches the second colored layer. The first substrate may be configured to selectively transmit a component of visible light from outside the device into at least part of the cells, wherein the second colored layer may be configured such that a substantial amount of the component of visible light that reaches the second colored layer is not reflected at the second colored layer.

Another aspect of the invention provides a plasma display device, which comprises: a first substrate colored with a first color; a second substrate opposite to the first substrate; a plurality of barrier ribs installed between the first and second substrates, wherein the plurality of barrier ribs define a plurality of cells; a plurality of sustain electrodes interposed between the first substrate and the plurality of cells; a first dielectric layer, wherein the plurality of sustain electrodes are interposed between the first substrate and the first dielectric layer; a plurality of address electrodes arranged between the plurality of cells and the second substrate; a second dielectric layer, wherein the plurality of address electrodes are interposed between the second dielectric layer and the second substrate; a phosphor layer formed within at least part of the cells; and wherein one or more of at least part of the second dielectric layer, the plurality of barrier ribs, and the phosphor layer is colored with a second color, wherein the first color and the second color are adapted to form a subtractive color mixing.

In the foregoing device, at least part of the second dielectric layer, the plurality of barrier ribs, or the phosphor layer may comprise a material to form the second color. The first substrate may comprise a glass plate and a film formed between the glass plate and the first dielectric layer, wherein the film is of the first color. The film may be formed on a substantially entire surface of the glass plate. The first substrate may comprise a glass plate incorporating a material of the first color. The first substrate comprises a first portion colored with the first color, wherein the one or more of at least part of the second dielectric layer, the barrier ribs, and the phosphor layer comprises a second portion colored with the second color, and wherein the first portion and the second portion may be substantially aligned with each other such that light transmitting through the first portion can reach the second portion. The first substrate may be configured to selectively transmit a component of visible light from outside the device into at least part of the cells, wherein the one or more of at least part of the second dielectric layer, the plurality of barrier ribs, and the phosphor layer may be configured to absorb a substantial amount of the component of visible light. The first substrate may be configured to selectively transmit a component of visible light from outside the device into at least part of the cells, wherein the one or more of at least part of the second dielectric layer, the plurality of barrier ribs, and the phosphor layer may be configured such that a substantial amount of the component of visible light is not reflected.

Yet another aspect of the invention provides a plasma display panel that improves the bright room contrast by decreasing the reflection brightness by using a complementary color relationship between a colored substrate and one of a colored dielectric layer, a colored barrier structure, and colored phosphor layers.

A further aspect of the present invention provides a plasma display panel comprising: a first substrate and a second substrate opposite to the first substrate; discharge electrodes arranged between the first and second substrates; a dielectric layer in which the discharge electrodes are buried; a barrier structure installed between the first and second substrates, defining discharge cells; and phosphor layers formed within the discharge cells, wherein the first substrate is colored with a first coloring layer, and one of the dielectric layer, the barrier structure, and the phosphor layers is colored with a second coloring layer.

The first and second coloring layers may be formed by a subtractive mixture. The first and second coloring layers may have a complementary color relationship. The first substrate may be a substrate which transmits visible light generated during discharge. The first coloring layer may be formed on a portion of the first substrate that corresponds to a portion of one of the dielectric layer, the barrier structure, and the phosphor layers that is covered by the second coloring layer. The first coloring layer may be formed on the entire area of the first substrate. A mixture of the first and second coloring layers may be a color close to black.

### BRIEF DESCRIPTION OF THE DRAWINGS

The above features and advantages will become more apparent by describing in detail exemplary embodiments with reference to the attached drawings in which:

FIG. 1 is an exploded perspective view illustrating a part of a plasma display panel (PDP) according to an embodiment of the present invention;

FIG. 2 is a cross-sectional view taken along line I-I of FIG. 1;

FIG. 3 is a cross-sectional view of a PDP according to an embodiment of the present invention;

FIG. 4 is a cross-sectional view of a PDP according to an embodiment of the present invention;

FIG. 5 is a cross-sectional view of a PDP according to an embodiment of the present invention;

FIG. 6 is a cross-sectional view of a PDP according to an embodiment of the present invention; and

FIG. 7 is a cross-sectional view of a PDP according to an embodiment of the present invention.

### DETAILED DESCRIPTION OF EMBODIMENTS

Various embodiments will now be described more fully with reference to the accompanying drawings.

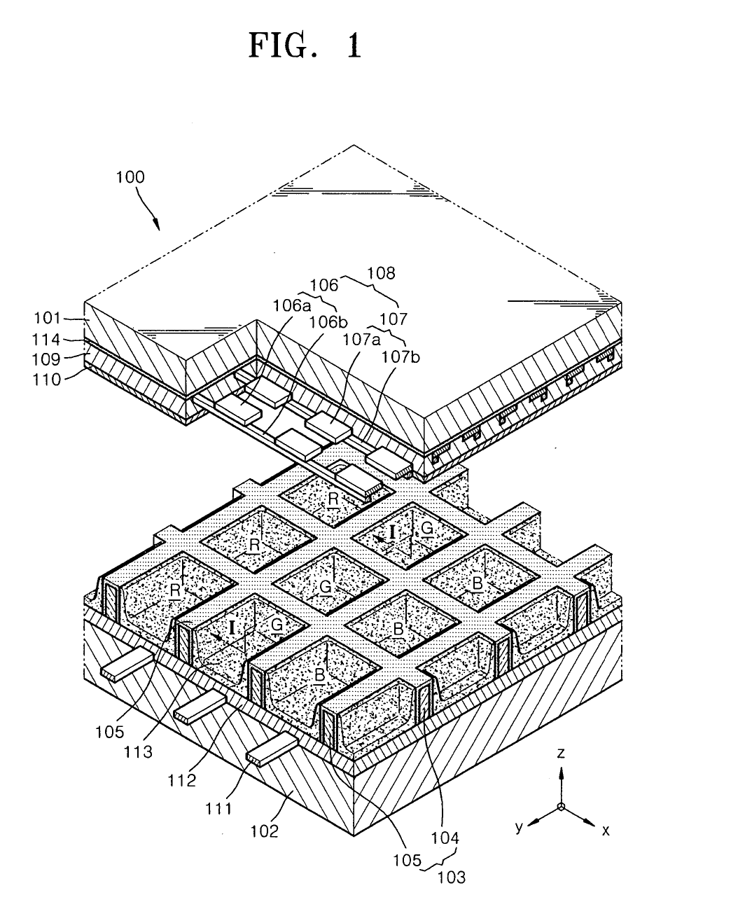

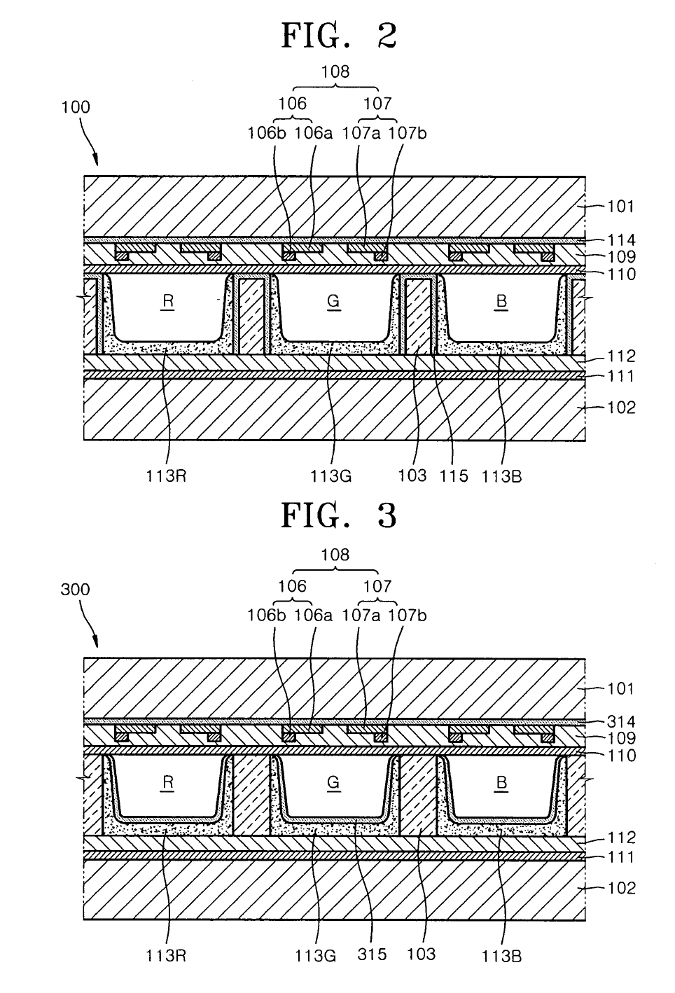

FIG. 1 is an exploded perspective view illustrating a part of a plasma display panel (PDP) 100 according to an embodiment of the present invention. FIG. 2 is a cross-sectional view of the PDP 100 in an assembled state that is taken along line I-I of FIG. 1. Referring to FIGS. 1 and 2, the PDP 100 includes a first substrate 101 and a second substrate 102 parallel to the first substrate 101. Frit glass (not shown) is coated on edges of facing surfaces of the first and second substrates 101 and 102 to enclose the internal discharge space between the first and second substrates 101 and 102.

A structure of a plurality of barrier ribs 103 that defines discharge cells in cooperation with the first and second substrates 101 and 102 is arranged between e first and second substrates 101 and 102. The barrier structure 103 includes first barrier ribs 104 arranged in the X direction of the PDP 100, and second barrier ribs 105 arranged in the Y direction of the PDP 100. The first and second barrier ribs 104 and 105 are integrally formed with each other and define discharge cells that form a lattice. Alternatively, the barrier structure 103 may have the other various shapes, such as, a meander type, a delta type, a waffle type, and a honeycomb type. The discharge spaces defined by the barrier structure 103 may have various shapes of horizontal cross-sections, such as, a polygonal shape other than a rectangular shape illustrated in FIG. 1, a circular shape, or an oval shape.

Sustain discharge electrode pairs 108 are arranged on the inside surface of the first substrate 101. Each of the sustain discharge electrode pairs 108 includes an X electrode 106 and a Y electrode 107 that are arranged in the X direction of the PDP 100. X electrodes 106 and Y electrodes 107 alternate in the Y direction of the PDP 100. Each of the X electrodes 106 includes first transparent electrodes 106a formed in the discharge cells in a one-to-one correspondence and arranged in the X direction of the PDP 100, and a first bus electrode 106b electrically connected to the first transparent electrodes 106a. Although the first transparent electrodes 106a illustrated in FIG. 1 have rectangular horizontal cross-sections, they may have horizontal cross-sections with shapes other than rectangles.

The Y electrodes 107 have substantially the same shapes as those of the X electrodes 106. Each of the Y electrodes 107 includes second transparent electrodes 107a formed in the discharge cells in a one-to-one correspondence and arranged in the X direction of the PDP 100, and a second bus electrode 107b electrically connected to the second transparent electrodes 107a. The first and second transparent electrodes 106a and 107a are located within the discharge cells and spaced apart from each other. A discharge gap is formed between each pair of the first and second transparent electrodes 106a and 107a.

The first and second transparent electrodes 106a and 107a are implemented as transparent conductive films, such as, indium tin oxide (ITO) films, in order to improve the aperture ratio of the first substrate 101. The first and second bus electrodes 106b and 107b are formed of a high conductive metal, such as, silver paste or a chrome-copper-chrome alloy, in order to improve the electrical conductivity of the first and second transparent electrodes 106a and 107b. The space between every adjacent pairs of X and Y electrodes 106 and 107 corresponds to a non-discharge area. A black strip may be formed in the non-discharge area in order to improve the contrast.

The X and Y electrodes 106 and 107 are buried in a first dielectric layer 109. The first dielectric layer 109 is formed of a high dielectric material, such as, ZnO—B₂O₃—Bi₂O₃. The first dielectric layer 109 may be printed on either only portions of the first substrate 101 corresponding to the X and Y electrodes 106 and 107 or on the entire surface of the first substrate 101. A protection layer 110, such as, a magnesium oxide (MgO) layer, is deposited on the first dielectric layer 109 in order to protect the first dielectric layer 109 against external shocks and to increase the number of secondary electrons emitted.

Address electrodes 111 are arranged on the inside surface of the second substrate 102 and intersect the sustain discharge electrode pairs 108. The address electrodes 111 are buried in a second dielectric layer 112. The second dielectric layer 112 is formed of a high dielectric material, such as, PbO—B₂O₃—SiO₂. A discharge gas, such as, neon (Ne)-xenon (Xe) or helium (He)-xenon (Xe), exists within the discharge cells defined by the first and second substrates 101 and 102 and the barrier structure 103.

Phosphor layers 113, being excited by ultraviolet (UV) light generated from the discharge gas to emit visible light and having a plurality of colors in order to achieve color display, are formed within the discharge cells. Each of the phosphor layers 113 may be coated on any surface of each of the discharge cells. In the present embodiment, the phosphor layers 113 are coated on the inside surface of the second substrate 102 and the sidewalls of the barrier structure 103 so as to have a predetermined thickness. In the present embodiment illustrated in FIG. 1, the phosphor layers 113 include red phosphor layers 113R, green phosphor layers 113G, and blue phosphor layers 113B. However, the present invention is not limited to this configuration of the phosphor layers 113. In other words, the red, green, and blue phosphor layers 113R, 113G, and 113B may be replaced by phosphor layers with the other colors, or the phosphor layers 113 may further include phosphor layers with the other colors in addition to the red, green, and blue phosphor layers 113R, 113G, and 113B.

In a PDP, the brightness may be lowered to improve a bright room contrast. In order to lower the brightness of reflected light, a first dielectric layer may be colored with a color. However, the coloring the dielectric layer may change the characteristics of the first dielectric layer, which may requires the change of design parameters such as thickness of the layer and electric circuit design.

Thus, in a PDP according to an embodiment of the present invention, a substrate through which visible light passes is colored, and at least one of a barrier structure, a dielectric layer, and phosphor layers is colored with a color which is complementary to the color of the substrate. Thus, the reflection brightness of the PDP which is caused by external light decreases. In an embodiment, the inside surface of a glass plate of the first substrate 101 is colored with a first coloring layer or film 114. The first coloring layer 114 may be coated on the inside surface of the glass plate of the first substrate 101. In another embodiment, a glass plate of the first substrate 101 incorporates a coloring material added thereto and dispersed therein without an additional coloring layer. The sustain discharge electrode pairs 108 are arranged on the first coloring layer 114 and then buried in the first dielectric layer 109.

In some embodiments, the barrier structure 103 defining the discharge cells is installed on the upper surface of the second dielectric layer 112. Due to the installation of the barrier structure 103, a plurality of discharge spaces arranged in a matrix are formed in the PDP 100. Each barrier rib of the barrier structure 103 is colored with a second coloring layer 115. The second coloring layer 115 is coated on the entire outer surface of the barrier ribs of the barrier structure 103. In an embodiment, the second coloring layer 115 may be coated on only upper surfaces of the barrier ribs of the barrier structure 103 that face the first substrate 101. In certain embodiments, coloring material may be incorporated in the barrier structure 103.

The red phosphor layers 113R, the green phosphor layers 113G, and the blue phosphor layers 113B are formed in the discharge spaces such that each phosphor layer corresponds to each discharge cell. An array of a red phosphor 113R, a green phosphor layer 113G, and a blue phosphor layer 113B may be repeated in a direction of the PDP 100. Alternatively, a phosphor layer having relatively low luminous efficiency among the red, green, and blue phosphor layers 113R, 113G, and 113B may be further included in each array of the red, green, and blue phosphor layers 113R, 113G, and 113B. Alternatively, the red, green, and blue phosphor layers 113R, 113G, and 113B may be arranged in a vertical direction of the PDP 100 to form a delta shape. In other words, the construction and arrangement of phosphor layers are not limited to the embodiment illustrated in FIGS. 1 and 2.

The red phosphor layers 113R are formed of (Y,Gd)BO₃;Eu+³, the green phosphor layers 113G are formed of Zn₂SiO₄:Mn²⁺, and the blue phosphor layers 113B are formed of BaMgAl₁₀SiO₁₇:Eu²⁺. Alternatively, the blue phosphor layers 113B may be formed of CaMgSi₂O₃:Eu²⁺ or a mixture of BaMgAlloSiOi₇:Eu²⁺ and CaMgSi₂O₃:Eu²⁺.

In an embodiment, the first substrate 101 is a substrate through which visible light generated due to discharge transmits. The first coloring layer 114 is formed on the entire surface of the first substrate 101. Alternatively, the first coloring layer 114 may be formed on only portions of the first substrate 101 that correspond to the barrier structure 103 on which the second coloring layer 115 is formed.

The colors of the first and second coloring layers 114 and 115 form a subtractive color mixture. Specifically, the subtractive color mixture denotes a method of making a color by mixing cyan (i.e., bluish green), magenta (i.e., purple), and yellow that are the three primary colors. Infinite colors can be produced from cyan, magenta, and yellow. The secondary colors produced from the three primary light, the cyan, magenta, and the yellow are produced by subtracting or absorbing colors. For example, when yellow and magenta are overlapped together, red is formed, because the overlapped portion absorbs the wavelengths of green light and blue light and reflects red.

When two colors that are complementary to each other are mixed, an achromatic color, such as, gray or black, is produced. There are the other mixtures of two complementary colors, such as, a mixture of red and dark blue and a mixture of green and orange. A mixture denotes a mixture of two of the three primary colors, and there are countless mixtures of two complementary colors. The brightness and saturation of a color decrease as the subtractive mixture becomes complicated. A mixture of colors that are close to each other in a color circle becomes a neutral color. A mixture of colors far from each other in a color circle is close to gray. A mixture of complementary colors is close to black.

In the embodiment discussed above, the first substrate 101 and the barrier structure 103 are colored with the first and second coloring layers 114 and 115, respectively, to form a subtractive color mixture. In an embodiment, the first coloring layer 114 uses a color that can minimize the reduction the transmissivity of emitted light, and the second coloring layer 115 uses a highly reflective color other than black in order to prevent loss of light emitted by the red, green, and blue phosphor layers 113R, 113G, and 113B. In an embodiment, the colors of the first substrate 101 colored with the first coloring layer 114 and the barrier structure 103 colored with the second coloring layer 115 are complementary to each other, and then the reflection brightness of the PDP 100 is reduced and thus the bright room contrast is improved.

In certain embodiments, the first substrate selectively transmits a component of visible light from outside the PDP device into at least part of the cells, and the second colored layer may absorb about 80, 85, 90, 95, 98, 99 or 100% of the component of visible light that reaches the second colored layer. In some embodiments, the second colored layer may absorb the amount which may be within a range defined by two of the foregoing amounts of the component of visible light that reaches the second colored layer.

In certain embodiments, the first substrate selectively transmits a component of visible light from outside the device into at least part of the cells, about 80, 85, 90, 95, 98, 99 or 100% of the component of visible light that reaches the second colored layer may not be reflected at the second colored layer. In some embodiments, the amount which may be within a range defined by two of the foregoing amounts of the component of visible light that reaches the second colored layer may not be reflected at the second colored layer.

FIG. 3 is a cross-sectional view of a PDP 300 according to an embodiment of the present invention. Only characteristic portions of the present embodiment will now be described. Referring to FIG. 3, the PDP 300 includes the first substrate 101 and the second substrate 102 opposite to the first substrate 101. A first coloring layer 314 is formed on the inside surface of the first substrate 101. In another embodiment, the first substrate 101 is colored by way of mixing a coloring material used to form a glass plate of the first coloring layer 314 during the manufacture of the glass plate of the first substrate 101. In an embodiment, the first coloring layer may be formed on only areas of the inside surface of the first substrate 101 that face the barrier structure 103.

Red phosphor layers 113R, green phosphor layers 113G, and blue phosphor layers 113B are formed within the discharge spaces defined by the barrier structure 103 on the inside surface of the second substrate 102 such that each phosphor layer corresponds to each discharge cell. Second coloring layers 315 are formed on the upper surfaces of the red, green, and blue phosphor layers 113R, 113G, and 113B. In certain embodiments, the colors of the first and second coloring layers 314 and 35 are complementary to each other. Hence, the reflection brightness of the PDP 300 obtained by external light is reduced, and a reduction of the brightness is minimized to improve the bright room contrast.

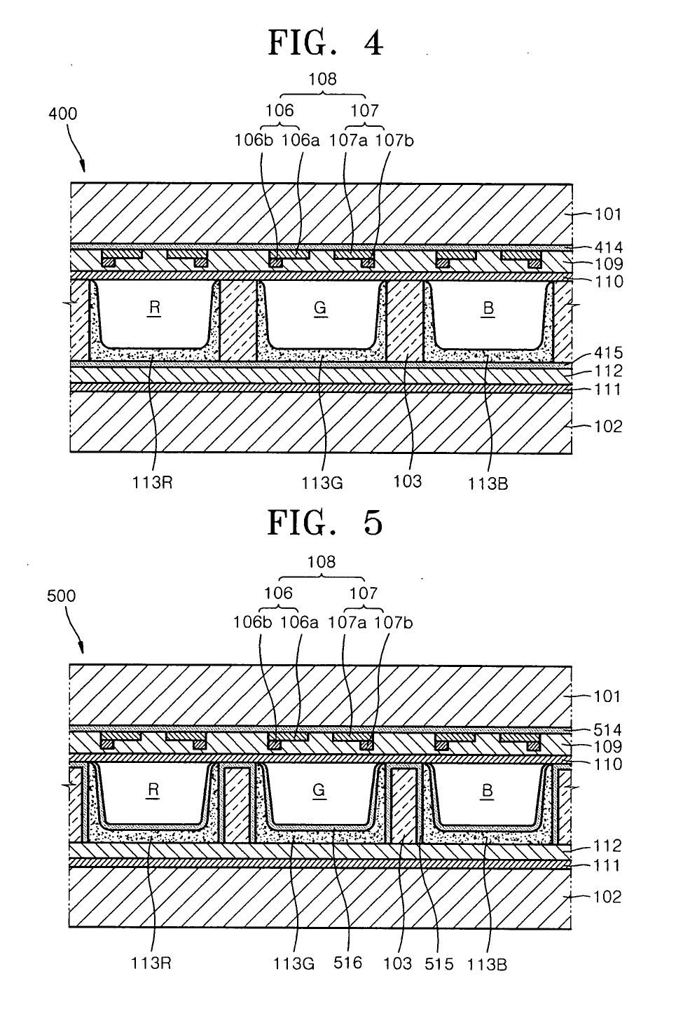

FIG. 4 is a cross-sectional view of a PDP 400 according to an embodiment of the present invention. Referring to FIG. 4, the PDP 400 includes the first substrate 101 and the second substrate 102 opposite to the first substrate 101. A first coloring layer 414 is formed on the inside surface of the first substrate 101. The first substrate 101 on which the first coloring layer 414 is formed corresponds to a substrate through which visible light penetrates.

A second dielectric layer 112 in which the address electrodes 111 are buried is formed on the inside surface of the second substrate 102. The barrier structure 103, defining discharge cells, is installed on the upper surface of the first dielectric layer 112. The red, green, and blue phosphor layers 113R, 113G, and 113B are formed within the discharge spaces defined by the barrier structure 103.

A second coloring layer 415 is formed between the upper surface of the second dielectric layer 112 and the barrier structure 103 and between the upper surface of the second dielectric layer 112 and the red, green, and blue phosphor layers 113R, 113G, and 113B. The second coloring layer 415 has a color complementary to the color of the first coloring layer 414. A mixture of the colors of the first and second coloring layers 415 and 414 produces a color close to black. Hence, the reflection brightness of the PDP 400 obtained by external light is decreased.

FIG. 5 is a cross-sectional view of a PDP 500 according to an embodiment of the present invention. Referring to FIG. 5, the PDP 500 includes the first substrate 101 and the second substrate 102 opposite to the first substrate 101. The first substrate 101 is a substrate through which visible light penetrates during discharge. A first coloring layer 514 is formed on the inside surface of the first substrate 101.

The barrier structure 103, defining discharge cells, is installed on the upper surface of the second substrate 102. The red, green, and blue phosphor layers 113R, 113G, and 113B are formed on the inside surface of the barrier structure 103. Second coloring layers 515 are formed on exposed surfaces of the barrier structure 103. The second coloring layers 515 may be formed on the entire exposed surface of the barrier structure 103 or on only upper areas of the exposed surface thereof, which faces the first substrate. Third coloring layers 516 may be formed on the upper surfaces of the red, green, and blue phosphor layers 113R, 113G, and 113B. The third coloring layers 516 have substantially the same colors as the second coloring layers 515.

The first coloring layer 514 is mixed with the second and third coloring layers 515 and 516 by a subtractive mixture method and maintains a complementary color relationship with second and third coloring layers 515 and 516. Hence, the reflection brightness of the PDP 500 obtained by external light is decreased.

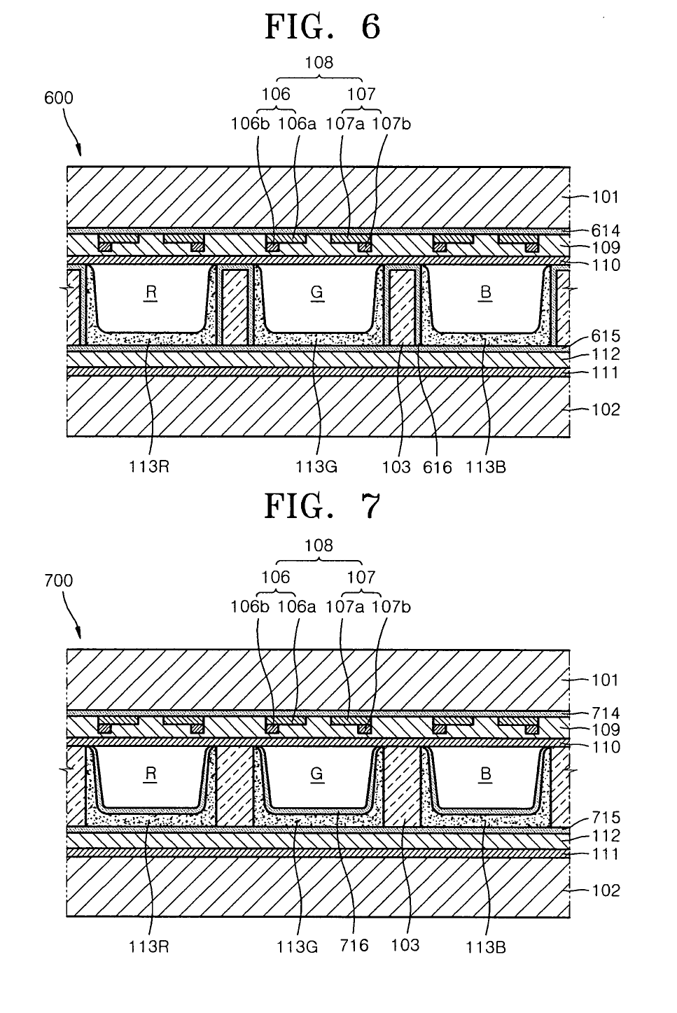

FIG. 6 is a cross-sectional view of a PDP 600 according to an embodiment of the present invention. Referring to FIG. 6, the PDP 600 includes the first substrate 101 and the second substrate 102 opposite to the first substrate 101. A first coloring layer 614 is formed on the inside surface of the first substrate 101. A second coloring layer 615 is formed between the upper surface of the second dielectric layer 112, in which the address electrodes 111 are buried, and the barrier structure 103 and between the upper surface of the second dielectric layer 112 and the red, green, and blue phosphor layers 113R, 113G, and 113B. Third coloring layers 616 are formed on exposed surfaces of the barrier structure 103. The second and third coloring layers 615 and 616 maintain a complementary color relationship with the first coloring layer 615 due to a subtractive mixture method. The third coloring layers 616 have substantially the same colors as the second coloring layer 615. Hence, the bright room contrast improves.

FIG. 7 is a cross-sectional view of a PDP 700 according to an embodiment of the present invention. Referring to FIG. 7, the PDP 700 includes the first substrate 101 and the second substrate 102 opposite to the first substrate 101. A first coloring layer 714 is formed on the inside surface of the first substrate 101. A second coloring layer 715 is formed between the upper surface of the second dielectric layer 112, in which the address electrodes 111 are buried, and the barrier structure 103 and between the upper surface of the second dielectric layer 112 and the red, green, and blue phosphor layers 113R, 113G, and 113B. Third coloring layers 716 are formed on the upper surfaces of the red, green, and blue phosphor layers 113R, 113G, and 113B. The second and third coloring layers 715 and 716 have the same colors and maintain a complementary color relationship with the first coloring layer 714 due to a subtractive mixture. Hence, the reflection brightness of the PDP 700 obtained by external light is decreased.

A PDP according to embodiments of the present invention as described above may have the following effects. First, unnecessary reflecting light caused by external light is maximally blocked. Thus, the bright room contrast is improved. Second, various mixtures of colors depending on the request of a user are possible. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display device comprising:
a first substrate colored with a first color;
a second substrate opposite to the first substrate;
a plurality of barrier ribs interposed between the first and second substrates, wherein the plurality of barrier ribs define a plurality of cells;
a plurality of sustain electrodes interposed between the first substrate and the plurality of cells;
a first dielectric layer, wherein the plurality of sustain electrodes are interposed between the first substrate and the first dielectric layer;
a plurality of address electrodes arranged between the plurality of cells and the second substrate;
a second dielectric layer, wherein the plurality of address electrodes are interposed between the second dielectric layer and the second substrate;
a phosphor layer formed within at least part of the cells; and
a second colored layer colored with a second color formed on one or more of at least part of the second dielectric layer, the plurality of barrier ribs, and the phosphor layer, wherein the first color and the second color are adapted to form a subtractive color mixing.

2. The device of claim 1, wherein the first substrate comprises a glass plate and a film formed between the glass plate and the first dielectric layer, wherein the film is of the first color.

3. The device of claim 2, wherein the film is formed on a substantially entire surface of the glass plate.

4. The device of claim 1, wherein the first substrate comprises a glass plate incorporating a material of the first color.

5. The device of claim 1, wherein the first and second colors are substantially complementary.

6. The device of claim 1, wherein the first substrate is configured to substantially transmit visible light generated from at least part of the cells.

7. The device of claim 1, wherein the first substrate comprises a first portion colored with the first color, wherein the second colored layer comprises a second portion colored with the second color, and wherein the first portion and the second portion are substantially aligned with each other such that light transmitting through the first portion can reach the second portion.

8. The device of claim 1, wherein the plurality of barrier ribs have side surfaces defining walls of the cells, wherein the second colored layer is formed on substantially the entirety of the side surfaces.

9. The device of claim 1, wherein the plurality of barrier ribs have top surfaces opposing the first substrate, wherein the second colored layer is formed on substantially the entirety of the top surfaces.

10. The device of claim 1, wherein the first substrate is configured to selectively transmit a component of visible light from outside the device into at least part of the cells, wherein the second colored layer is configured to absorb a substantial amount of the component of visible light that reaches the second colored layer.

11. The device of claim 1, wherein the first substrate is configured to selectively transmit a component of visible light from outside the device into at least part of the cells, wherein the second colored layer is configured such that a substantial amount of the component of visible light that reaches the second colored layer is not reflected.

12. A plasma display device comprising:
a first substrate colored with a first color;
a second substrate opposite to the first substrate;
a plurality of barrier ribs installed between the first and second substrates, wherein the plurality of barrier ribs define a plurality of cells;
a plurality of sustain electrodes interposed between the first substrate and the plurality of cells;
a first dielectric layer, wherein the plurality of sustain electrodes are interposed between the first substrate and the first dielectric layer;
a plurality of address electrodes arranged between the plurality of cells and the second substrate;
a second dielectric layer, wherein the plurality of address electrodes are interposed between the second dielectric layer and the second substrate;
a phosphor layer formed within at least part of the cells; and
wherein one or more of at least part of the second dielectric layer, the plurality of barrier ribs, and the phosphor layer is colored with a second color, wherein the first color and the second color are adapted to form a subtractive color mixing.

13. The device of claim 12, wherein at least part of the second dielectric layer, the plurality of barrier ribs, or the phosphor layer comprises a material to form the second color.

14. The device of claim 12, wherein the first substrate comprises a glass plate and a film formed between the glass plate and the first dielectric layer, wherein the film is of the first color.

15. The device of claim 13, wherein the film is formed on a substantially entire surface of the glass plate.

16. The device of claim 12, wherein the first substrate comprises a glass plate incorporating a material of the first color.

17. The device of claim 12, wherein the first substrate comprises a first portion colored with the first color, wherein the one or more of at least part of the second dielectric layer, the barrier ribs, and the phosphor layer comprises a second portion colored with the second color, and wherein the first portion and the second portion are substantially aligned with each other such that light transmitting through the first portion can reach the second portion.

18. The device of claim 12, wherein the first substrate is configured to selectively transmit a component of visible light from outside the device into at least part of the cells, wherein the one or more of at least part of the second dielectric layer, the plurality of barrier ribs, and the phosphor layer is configured to absorb a substantial amount of the component of visible light.

19. The device of claim 12, wherein the first substrate is configured to selectively transmit a component of visible light from outside the device into at least part of the cells, wherein the one or more of at least part of the second dielectric layer, the plurality of barrier ribs, and the phosphor layer is configured such that a substantial amount of the component of visible light is not reflected.
